(19) United States
(12) Patent Application Publication
(10) Pub. No.: US 2015/0379555 A1
(43) Pub. Date: Dec. 31, 2015

(54) REFERRAL BASED, NODE-DRIVEN MOBILE AND DISPLAY ADVERTISING PLATFORM WITH TRACKABLE SOCIAL ENGAGEMENT AND REAL-TIME BIDDING OPTIMIZATION

(71) Applicant: Spreeify, Inc., Encino, CA (US)

(72) Inventor: Ruben Kriss Dua, Encino, CA (US)

(21) Appl. No.: 14/319,468

(22) Filed: Jun. 30, 2014

(51) Int. Cl. G06Q 30/02; G06F 17/30

(52) U.S. Cl. CPC G06Q 30/0242; G06Q 30/0269; G06Q 30/0277; G06Q 30/0275; G06F 17/3053; G06Q 50/01

(57) ABSTRACT

The technology described herein includes a display ad development tool that facilitates development of an interactive display ad by providing developers with the ability to drag and drop and/or otherwise upload a creative (e.g., image file) to the system and add trackable social engagement objects directly onto the creative. The system generates advertising code for the interactive display ad and automatically places or posts the interactive display ad to a selected advertisement network campaign manager network. A tracking and analysis tool that tracks the resulting social engagements using a node-based structure. The tracked social engagement information is processed to determine various social engagement metrics which can be used to determine, for example, optimal target audience information for the interactive display ad. Once determined, the technology can utilize the optimal target audience information to automatically bid (e.g., via real-time bidding) on media inventory to increase social conversions for the advertisement.

### BACKGROUND

Internet or Online advertising typically uses online media to communicate with consumers and to promote products, brands, services, public service announcements, corporate or political groups, etc. This style of advertising is most commonly performed via the Internet, often through the use of an advertisement server (ad server) that can deliver a variety of advertising units.

Effectiveness of a particular advertisement (or advertisement campaign) is often measured in impressions, clicks, and transactions (also referred to as conversions). An impression is a measure of the number of times an advertisement is seen. More specifically, an impression is a measurement of responses from a Web server to a page request from a user browser. Each time an ad displays, it is counted as one impression in a measure of the number of times the ad is seen. The advertisements typically include a call to action (CTA). Thus, by clicking on the advertisement, a user is taken to a Merchants website where the user can make a transaction. The number of clicks and transactions are also measured.

Unfortunately, Internet or Online advertisers have long suffered from decreasing engagement (impressions, clicks, and/or conversion rates) in online advertisements. Social media (e.g., Facebook, Twitter, Pinterest, Instagram, Linkedin) provides a platform for increasing engagement for online advertisements; however, these two worlds have remained highly disparate. Accordingly, it would be beneficial to marry Internet or Online advertising with social media to increase engagement.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a block diagram illustrating an example environment in which a referral based, node-driven social engagement platform 130 can operate to facilitate various advertising technologies.

FIG. 2 is a block diagram illustrating example components of a host system (or server) 200 able to facilitate various advertising technologies including embedding and tracking of social engagement objects.

FIG. 3 is a diagram illustrating example tracking operation of a referral based, node-driven advertising platform.

FIG. 4 is a data flow diagram depicting an example process illustrating development of an interactive display ad.

FIG. 5 is a data flow diagram depicting an example process illustrating tracking of social engagements using a node-based structure.

FIG. 6 is a data flow diagram depicting an example process illustrating real-time bidding using social engagement metrics.

FIG. 7 is an example user interface illustrating an example display ad development interface.

FIG. 8 is an example node-based social engagement tracking structure illustrating tracking of social engagement metrics in the referral based, node-driven advertising platform.

FIG. 9 is an example node-based social engagement tracking structure illustrating modifications to a media strategy based on revisions or modifications to the optimal target audience (or referrers) and/or the characteristics of the optimal target audience (or referrers).

FIG. 10 is a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the present disclosure describe a referral based, node-driven mobile and display advertising platform with trackable social engagement and real-time bidding optimization. The advertising platform avoids or reduces costly custom display ad development with an easy to use display ad development tool (or engine). Furthermore, the trackability and real-time media bidding functionality increase impressions, clicks and conversions for advertisements (or advertisement campaigns).

In some embodiments, the referral based, node-driven advertising platform includes a display ad development tool (or engine) that facilitates development of an interactive display ad. More specifically, the display ad development tool provides developers with the ability to drag and drop and/or otherwise upload a creative (e.g., image file) to the system and add trackable social engagement objects directly onto the creative. The system can then generate advertising code for the interactive display ad and automatically place or post the interactive display ad to one or more selected advertisement network campaign manager networks (e.g., Google, AOL, OpenX, Yahoo, Bing, PubMatic, AppNexus, MoPub etc.). The advertising platform automatically ensures that the interactive advertisement complies with interactive advertising bureau (IAB) requirements/standards and is optimized for various client device form factors (e.g., desktop, tablet, mobile).

In some embodiments, the referral based, node-driven advertising platform includes a tracking functionality that allows the platform to track social engagements using a node-based structure. As described herein, the term social engagement generally includes any interaction with an interactive advertisement such as, for example, social impressions, social clicking, and social conversions. The tracking functionality allows the advertising platform to track the social engagement of an individual referrer and attribute network effects of the social engagement to the individual referrer. In some embodiments, the referrer (i.e., the user interactive with the advertisement) can receive a coupon directly from ad unit. The coupon can be shared and/or downloaded/emailed.

In some embodiments, the tracked social engagement information can be processed and analyzed by the referral based, node-driven advertising platform to determine various social engagement metrics. For example, the tracking and analysis tool can track the social engagements to determine the top social referrals based on social engagement. The referral based, node-driven advertising platform can include a real-time bidding (RTB) tool or engine that uses the social engagement metrics to determine, for example, optimal target audience information for the interactive display ad. An initial media buy strategy is then modified based on the optimal target audience information and ad tags are updated to reflect any changes. Once the ad tags are updated, the RTB tool can utilize the updated or modified media buy strategy to automatically bid (e.g., via real-time bidding) on media inventory to increase social engagement for the advertisement campaign. In some embodiments, the ad tags are software codes that an advertiser (or 3rd party marketer) provides to a publisher or ad network (the advertisement network campaign manager network) that calls the advertiser's ad server for the purposes of displaying an advertisement.

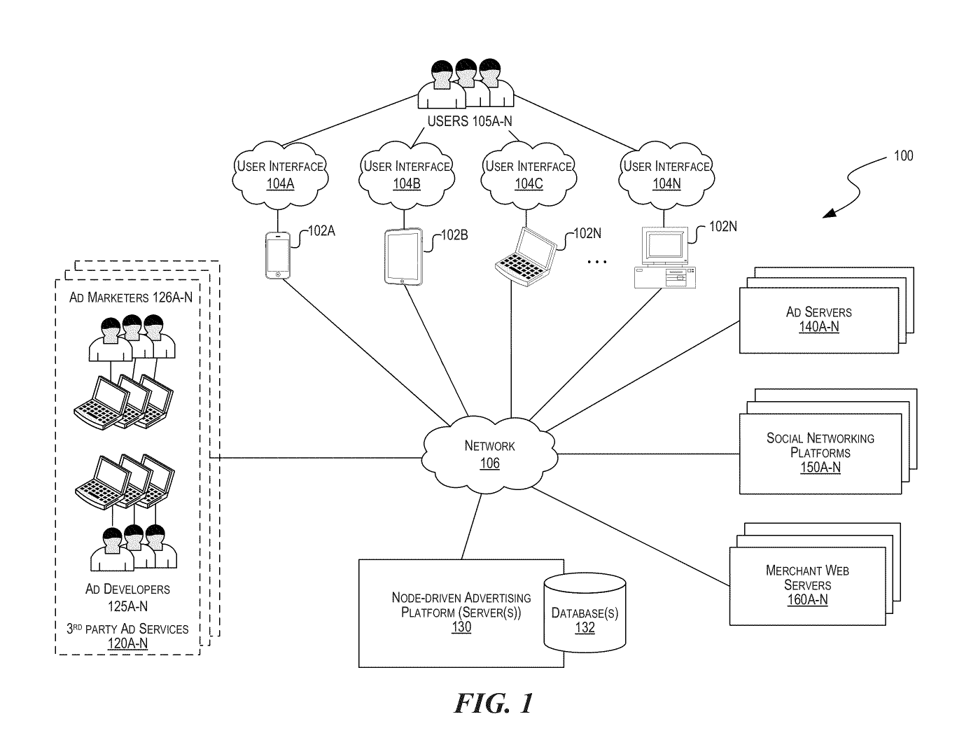

FIG. 1 is a block diagram illustrating an example environment 100 in which a referral based, node-driven social engagement platform 130 can operate to facilitate various advertising technologies. More specifically, among other features, the referral based, node-driven social engagement platform 130 can allow advertisers to embed and track social engagement objects in standard advertising display ads. In the example of FIG. 1, the example environment 100 includes users 105A-N operating various client (or user) devices 102A-N by way of various user interfaces 104A-N, 3rd party advertising services 120A-N, advertisement (ad) servers 140A-N, social networking platforms 150A-N, and merchant web servers 160A-N.

The referral based, node-driven social engagement platform 130 can be any system and/or device, and/or any combination of devices/systems that is able to communicate with user devices 102A-N, 3rd party ad services 120A-N, ad servers 140A-N, social networking platforms 150A-N and/or merchant web servers 160A-N in order to facilitate the various advertising technologies described herein including embedding and tracking of social engagement objects in standard advertising display ads. The referral based, node-driven social engagement platform 130 can be, but is not limited to, a server desktop, a desktop computer, a computer cluster, a mobile computing device such as a notebook, a laptop computer, a handheld computer, a mobile phone, a smart phone, a PDA, a Blackberry device, Android device, Firefox Phone, Amazon phone a Treo, and/or an iPhone, etc. In the example of FIG. 1, the referral based, node-driven social engagement platform 130 is illustrated as a discrete component; however, the referral based, node-driven social engagement platform 130 can be physically and/or functionally distributed.

The client devices or user devices 102A-N can be any system and/or device, and/or any combination of devices/systems that is able to establish a connection with another device, a server and/or other systems within the network-based environment 100. The client devices or user devices 102A-N typically include display or other output functionalities to present data exchanged between the devices to a user. For example, the client devices can be, but are not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, client devices or user devices 102A-N are coupled to a network 106. In some embodiments, the devices 102A-N may be directly connected to one another.

The network 106, over which client devices or user devices 102A-N and the host server 124 communicate, may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc. The network 106 can be any collection of distinct networks operating wholly or partially in conjunction to provide connectivity to the client devices or user devices 102A-N and host server 124 and may appear as one or more networks to the serviced systems and devices. In one embodiment, communications to and from client devices or user devices 102A-N can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal Area Network (PAN), a Campus Area Network (CAN), a Metropolitan Area Network (MAN), a Wide Area Network (WAN), a Wireless Wide Area Network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, Enhanced Data rates for GSM Evolution (EDGE), General Packet Radio Service (GPRS), enhanced GPRS, messaging protocols such as, TCP/IP, SMS, MMS, Extensible Messaging and Presence Protocol (XMPP), Real Time Messaging Protocol (RTMP), Instant Messaging and Presence Protocol (IMPP), instant messaging, USSD, IRC, or any other wireless data networks or messaging protocols.

In some embodiments, the referral based, node-driven social engagement platform 130 provides advertisement, referral, and tracking data to be stored in one or more databases 132 and can retrieve data stored in the databases for various analytics, reporting, and adjustment of real-time bidding for media inventory. Among other items, the one or more databases 132 can store files indicating display ad advertisements (e.g., image files), node-based social engagement tracking information, and real-time bidding information. As shown, the one or more databases 132 are included, wholly or partially, within the referral based, node-driven social engagement platform 130. However, in some embodiments, the one or more databases 132 can be one or more discrete components. Additionally, the one or more databases 132 and/or the referral based, node-driven social engagement platform 130 may be physically and/or functionally distributed.

As discussed, the one or more databases 132 may be communicatively coupled to the referral based, node-driven social engagement platform 130 and configured to store various content, software, descriptive data, images, system information, drivers, and/or any other data item or file utilized by other components of the referral based, node-driven social engagement platform 130. The one or more databases 132 may be managed by a database management system (DBMS), for example but not limited to, Oracle, DB2, Microsoft Access, Microsoft SQL Server, PostgreSQL, MySQL, FileMaker, etc. The one or more databases 132 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

The 3rd party ad services 120A-N can include ad marketers 126A-N and/or ad developers 125A-N. The ad marketers 126A-N can be hired by a merchant to develop an (initial) marketing strategy (e.g., determine an initial target audience). Likewise, the ad developers 125A-N can be hired by a merchant to develop the advertisements. Alternatively, some or all of the 3rd party ad services 120A-N can be performed by the merchant (e.g., in-house).

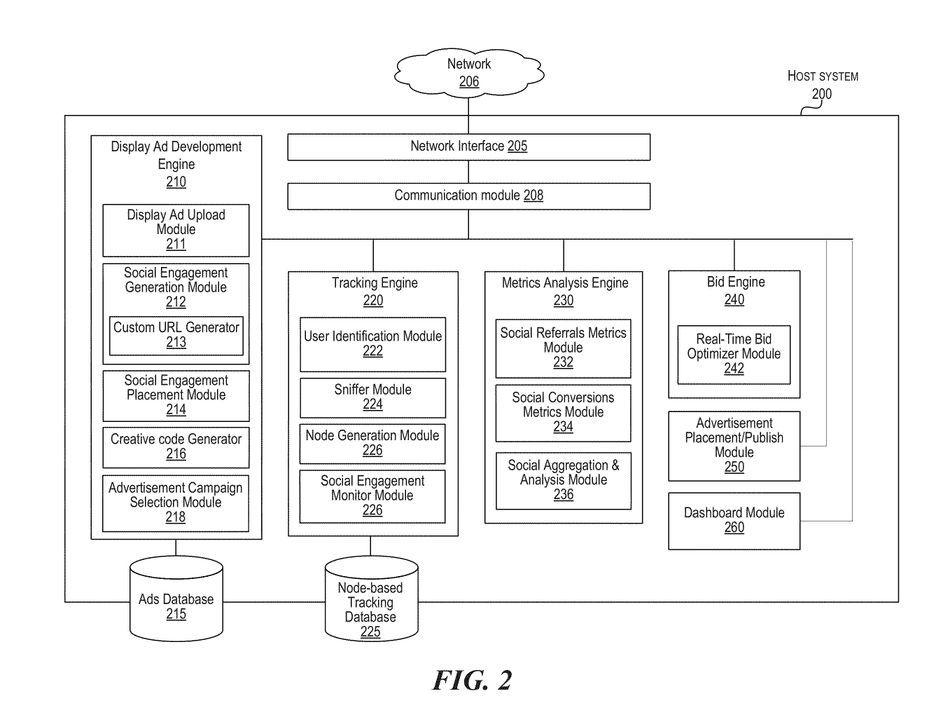

FIG. 2 is a block diagram illustrating example components of a host system (or server) 200 able to facilitate various advertising technologies including embedding and tracking of social engagement objects, according to an embodiment. The host system 200 may be the node-driven social engagement platform 130 of FIG. 1, although alternative configurations are possible. In the example of FIG. 2, the host system 200 is communicatively coupled to an ads database 215, a node-based tracking database 225, and a network 206. The ads database 215 and the node-based tracking database 225 may be the one or more databases 132 of FIG. 1 and the network 206 may be the network 106 of FIG. 1, although alternative configurations are possible.

The host system 200, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software. In some embodiments, some or all of the host system 200 modules described with respect to FIG. 2 may be included, alternatively or additionally, in whole or in part, within a source device or destination device.

In the example of FIG. 2, the host system 200 includes a network interface 205, a communication module 208, a display ad development engine 210, a tracking engine 220, a metrics analysis engine 230, a bid engine 240, an advertisement placement/publish engine 250, and a dashboard 260. Additional or fewer modules can be included. As shown, the ads database 215 and the node-based tracking database 225 are partially or wholly internal to the host system 200. However, the ads database 215 and the node-based tracking database 225 can alternatively or additionally be coupled to the host server 200 over network 206.

The network interface 205 can be one or more networking devices that enable the host server 140 to mediate data in a network with an entity that is external to the server, through any known and/or convenient communications protocol supported by the host and the external entity. The network interface 205 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The communications module 208 is communicatively coupled to the network interface 205 to manage one or more communication sessions over multiple communications protocols. The communications module 208 receives data, information, commands, requests, and/or text-based messages over a network. Since the communications module 208 is typically compatible with receiving and/or interpreting data originating from various communication protocols, the communications module 208 is able to establish parallel and/or serial communication sessions with agents.

The display ad development engine 210 can be any combination of software agents and/or hardware components able to facilitate development of an interactive advertisement. In the example of FIG. 2, the display ad development engine 210 includes a display ad upload module 211, a social engagement generation module 212, a social engagement placement module 214, a creative code generator 216 and an advertisement campaign selection module 218. Additional or fewer engines are possible.

In some embodiments, the display ad upload module 211 is configured to facilitate drag and drop of a creative (e.g., image file) onto the development interface. The display ad upload module 211 may, alternatively or additionally, include the ability for a developer to provide a file path (e.g., local or remote to the user device) to the creative for upload to the development interface.

In some embodiments, the social engagement generation module 212 is configured to create selected trackable social engagement items. As shown, the social engagement generation module 212 includes a custom URL generator 213. The custom URL generator 213 configured to create custom links for one or more of the selected trackable social engagement objects.

In some embodiments, the social engagement placement module 214 is configured to receive placement information from the developer for the selected trackable social engagement objects. The placement information is used to identify locations on the creative for embedding the selected trackable social engagement objects.

In some embodiments, the creative code (SWF, HTML5, Script or iFrame) generator 216 is configured to create a display code for the interactive advertisement or creative. As discussed herein, the display code can be an iFrame code or link, an HTML 5 code or ad tag, a SWF or HTML zip file etc. In some embodiments, the code (e.g., iFrame code) replaces the graphic and defines the interactive display ad (or advertisement).

In some embodiments, the advertisement campaign selection module 218 is configured to select one or more advertisement network campaign manager network (ad exchanges/networks) and optionally automatically deploy the interactive advertisement to the selected advertisement network campaign manager network in conjunction with the advertisement placement/publish module 250.

The tracking engine 220 can be any combination of software agents and/or hardware components able to facilitate tracking of social engagement metrics in the referral based, node-driven advertising platform. In the example of FIG. 2, the tracking engine 220 includes a user identification module 222, a node generation module 226, and a social engagement monitor module 226. Additional or fewer engines are possible.

In some embodiments, user identification module 222 and the sniffer module 224 are configured to identify information and/or other additional information about the referrer. For example, the advertising platform can determine the referrer's user identifier (ID), geolocation information, Internet Protocol (IP) address, client device type, etc. The identity and other additional information can be determined through the use of cookies, a sniffer for the IP address, etc.

In some embodiments, the node generation module 226 is configured to create a node in a node-based tracking structure. The node associates the identity (or userID) of the referrer with the unique reference so that future social engagements, e.g., reshares and/or social conversions can be tracked and attributed to the particular referrer.

In some embodiments, the social engagement monitor module 226 is configured to monitor for the future social engagements, e.g., reshares and/or social conversions can be tracked and attributed to the particular referrer.

The metrics analysis engine 230 can be any combination of software agents and/or hardware components able to analyze the tracked social engagements using a node-based structure. In the example of FIG. 2, the metrics analysis engine 230 includes social referrals metrics module 232, a social conversions metrics module 234, and a social aggregation & analysis module 236. Additional or fewer engines are possible.

In some embodiments, the social referrals metrics module 232 is configured to track social referrals in the node-based structure.

In some embodiments, the social conversions metrics module 234 is configured to track social conversions in the node-based structure.

In some embodiments, the social aggregation & analysis module 236 is configured to analyze the social engagement metrics for advertisements. For example, when social engagement metrics are updated, a social engagement efficacy for the various referrers is determined. In some embodiments, a referrer's social engagement efficacy is determined based on her ability, effectiveness, success, productiveness, potency, and/or power in producing social engagements such as, for example, reshares and social conversions. The various referrers may be optionally ranked according to their corresponding social engagement efficacy. Additionally, an optimal target audience (or optimal referrers) may be determined. In some embodiments, identification of the optimal target audience include identification of characteristics of the optimal target audience (or referrers). In some embodiments, referrers are identified that exceed a particular threshold. For example, referrers may be identified for being in a top percentage threshold (e.g., top 5 or 10 percent) of refers as determined by their corresponding social engagement efficacy and/or ranks. In some embodiments, the various referrers are ranked to determine the top social referrers based on social engagement efficacy. The top referrers may be referred to herein as brand evangelists because when these referrers social share interactive advertisements with their networks, the users of their networks tend to social engage with the ad.

The bid engine 240 can be any combination of software agents and/or hardware components able to use social engagement metrics to determine, for example, optimal target audience information for the interactive display ad. In the example of FIG. 2, the bid engine 240 includes a real-time bid optimizer module 242. Additional or fewer engines are possible.

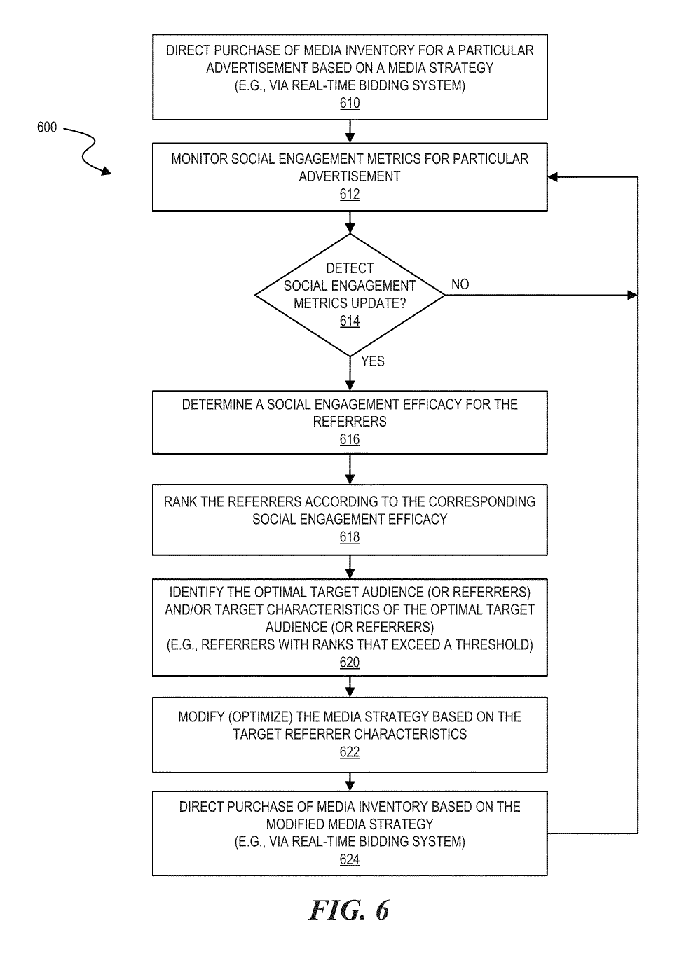

In some embodiments, the real-time bid optimizer module 242 determines a media buy strategy that is then modified based on the optimal target audience information and ad tags are updated to reflect any changes. Once the ad tags are updated, the RTB tool can utilize the updated or modified media busy strategy to automatically bid (e.g., via real-time bidding) on media inventory to increase social engagement for the advertisement campaign. This process is discussed in greater detail with reference to FIG. 6.

The dashboard module 260 can be any combination of software agents and/or hardware components able to access metrics in the host system and graphically display them to a user via the network.

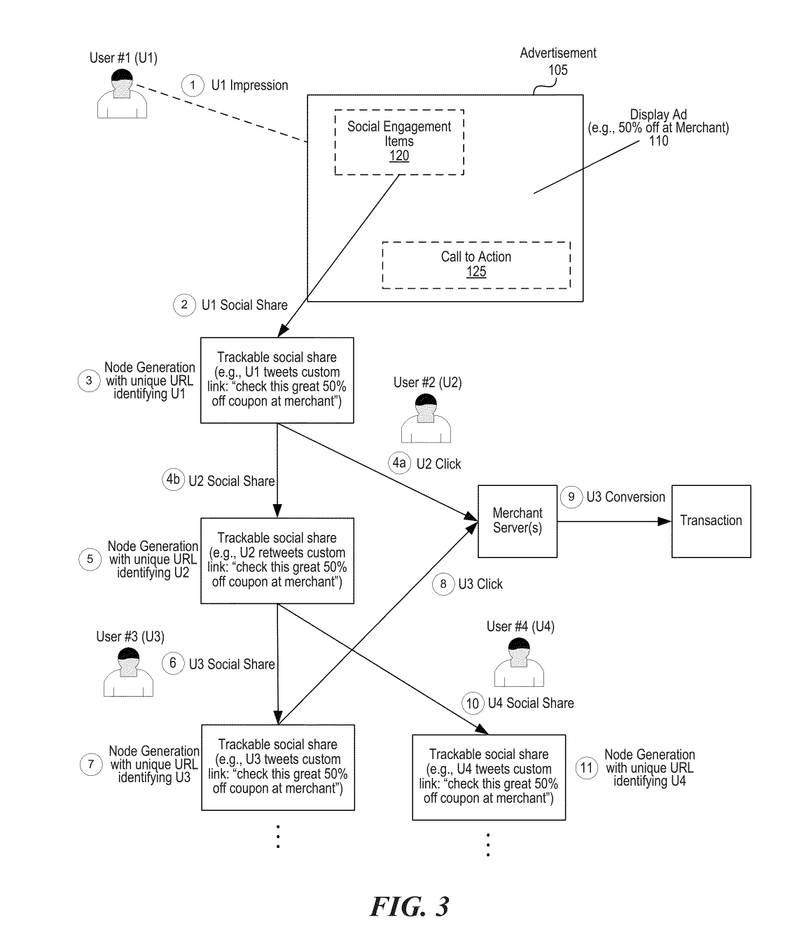

FIG. 3 depicts a diagram graphically illustrating example tracking operation 300, according to an embodiment. Specifically, FIG. 3 illustrates an example of tracking social engagements associated with an advertisement 105 and attributing the social engagements to one or more individual referrers (or users). Advertisement 105 displays a display ad 110 having trackable social engagement items 120 and a call to action 125 thereon.

Initially at time 1, a user U1 sees the advertisement 105 in a user browser. At time 2, user U1 socially shares the advertisement 105 by clicking on one of the trackable social engagement items 120 resulting in generation of a first unique link (URL) and a first node associating user U1 with the first unique link (URL). In the example of FIG. 3, user U1 tweets a custom link: “check this great 50% off coupon at merchant.”

At time 4a, user U2 clicks on the social share taking the user to the merchant server. No conversion is recorded. At time 4b, user U2 reshares the social share resulting in generation of a second unique link (URL) and a second node associating the second user U2 with the second unique link (URL). For example, user U2 retweets the custom link: “check this great 50% off coupon at merchant.” Subsequently, at times 6 and 10 respectively, users U3 and users U4 retweet the retweet. Additionally, at time 8, user U3 clicks on the link retweeted by user U2 and is taken to the merchant server where the user U3 converts resulting in a social conversion for users U1 and/or U2. In this manner, the tracking functionality allows the advertising platform to track social engagement of an individual referrer and attribute network effects of the social engagement to the individual referrer.

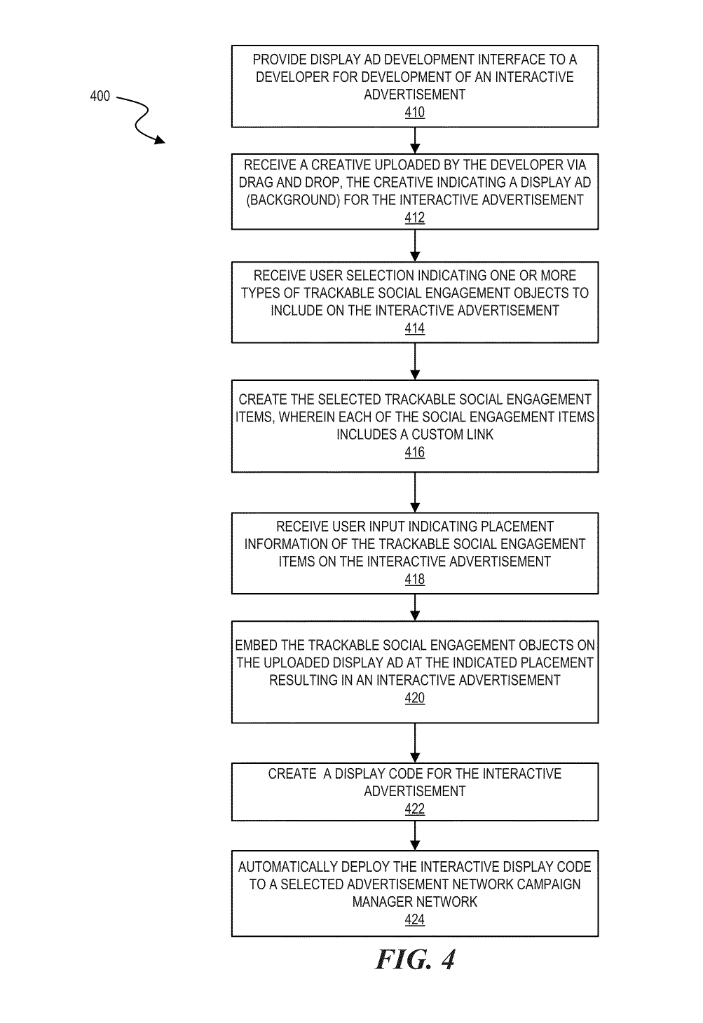

FIG. 4 is a data flow diagram depicting an example process 400 illustrating development of an interactive display ad, according to an embodiment. Components of a referral based, node-driven advertising platform such as, for example, referral based, node-driven advertising platform 130 of FIG. 1 or host system 200 of FIG. 2 can, among other functions, perform the example process 400.

To begin, an advertisement developer (“the developer”) accesses the advertising platform. In some embodiments, the advertising platform may require pre-registration and/or login credentials before the developer can access the system (or server). As discussed above, the developer can be, among other individuals, a merchant, an employee of the merchant, or a third-party advertisement developer hired by the merchant to generate online advertisements. In some embodiments, the advertising platform is accessible to the developer over a network such as, for example, network 106 of FIG. 1.

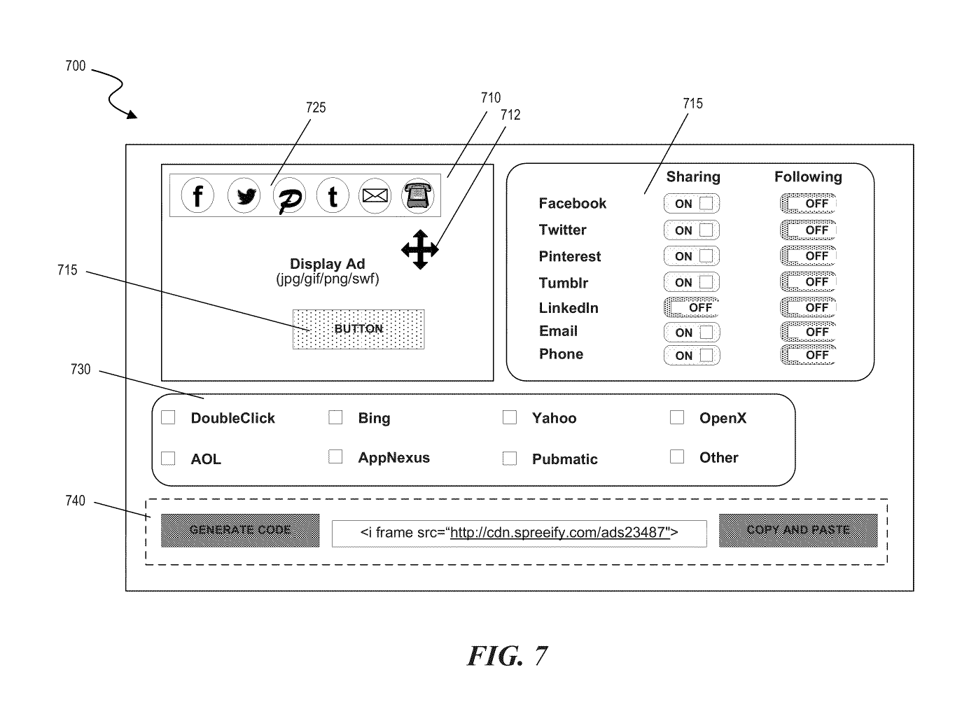

When the developer has accessed the advertising platform, at process 410, the advertising platform provides a display ad development interface to the developer. As discussed herein, the display ad development interface (or tool) facilitates development of an interactive display ad. An example display ad development interface is shown and discussed in greater detail below with reference to FIG. 7.

At process 412, the advertising platform receives a creative that is uploaded by the developer via a user device such as, for example, user device 102 of FIG. 1. The creative will be used as a display ad (or background) for the interactive advertisement. In some embodiments, the advertising platform provides the ability to drag and drop the creative onto the development interface. As discussed herein, the creative can be, for example, any image or animation file (e.g., a flat JPEG, GIF, PNG, SWF, MP4 etc.).

At process 414, the advertising platform receives a user selection indicating one or more types of trackable social engagement objects to include on the interactive advertisement. Each of the trackable social engagement objects corresponds to a particular social network on which the interactive advertisement can later be shared.

In some embodiments, a number of trackable social engagement objects will be available to the advertiser. Alternatively, an advertiser can define custom social engagement objects to be included on the interactive advertisement or custom social engagement objects in addition to the trackable social engagement objects provided by a user. In some embodiments, the display ad development interface may include radio buttons, on/off switches, checkboxes, etc., that allow a developer to select social engagement objects to include on the interactive advertisement.

Responsive to selection of trackable social engagement objects to be included on the interactive advertisement, at process 416, the advertising platform creates the selected trackable social engagement items. In some embodiments, creation of the trackable social engagement items includes creation of custom links for each of the selected trackable social engagement objects.

At process 418, the advertising platform receives user input indicating placement information for the selected trackable social engagement objects. Once the developer is satisfied with the placement of the selected trackable social engagement objects on the creative, at process 420, the advertising platform embeds the selected trackable social engagement objects onto the uploaded creative (e.g., image file) at the placement indicated by the developer.

At process 422, the advertising platform creates a display code for the interactive advertisement. As discussed herein, the display code can be an iFrame code or link, an HTML 5 file, SWF export, script or ad tag, etc. Lastly, at process 424, the advertising platform automatically deploys the interactive advertisement to a selected advertisement network campaign manager network.

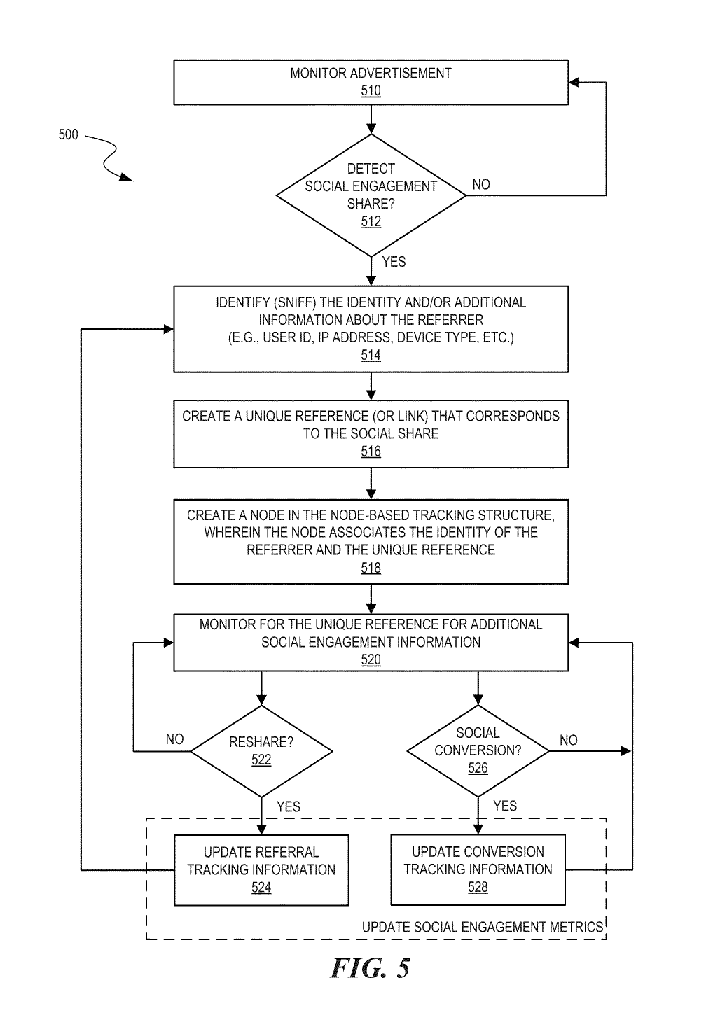

FIG. 5 is a data flow diagram depicting an example process 500 illustrating tracking of social engagements using a node-based structure, according to an embodiment. Components of a referral based, node-driven advertising platform such as, for example, referral based, node-driven advertising platform 130 of FIG. 1 or host system 200 of FIG. 2 can, among other functions, perform the example process 400.

To begin, a developer creates an interactive display ad that is posted to one or more selected advertisement network campaign manager networks (“ad network”). As discussed herein, ad tags can be used to convey media strategy (e.g., target audience data) to ad networks. The ad networks in turn use the ad tags to direct the interactive advertisement to the target audience. As discussed in greater detail with reference to FIG. 6, this process can be refined and modified (e.g., via real-time bidding) throughout the lifecycle of the interactive advertisement.

At process 510, the advertising platform monitors the interactive advertisement for social engagement. In some embodiments, social engagement can include a user (or referrer) viewing and/or otherwise sharing the interactive advertisement by clicking on one of the trackable social engagement objects. For example, the user (or referrer) may share the interactive advertisement on her Twitter account by clicking on a trackable social engagement object corresponding to Twitter. In some embodiments, the user clicking on the trackable social engagement object activates a URL that is monitored by the advertising platform.

At decision process 512, the advertising platform determines if the social engagement share (e.g., the Twitter share) is detected. If the social engagement is not detected, the procedure returns to monitoring at process 510. If the social engagement is detected, at process 514, the advertising platform determines identity information and/or other additional information about the referrer. For example, the advertising platform can determine the referrer's user identifier (ID), geolocation information, Internet Protocol (IP) address, client device type, etc. The identity and other additional information can be determined through the use of cookies, a sniffer for the IP address, etc.

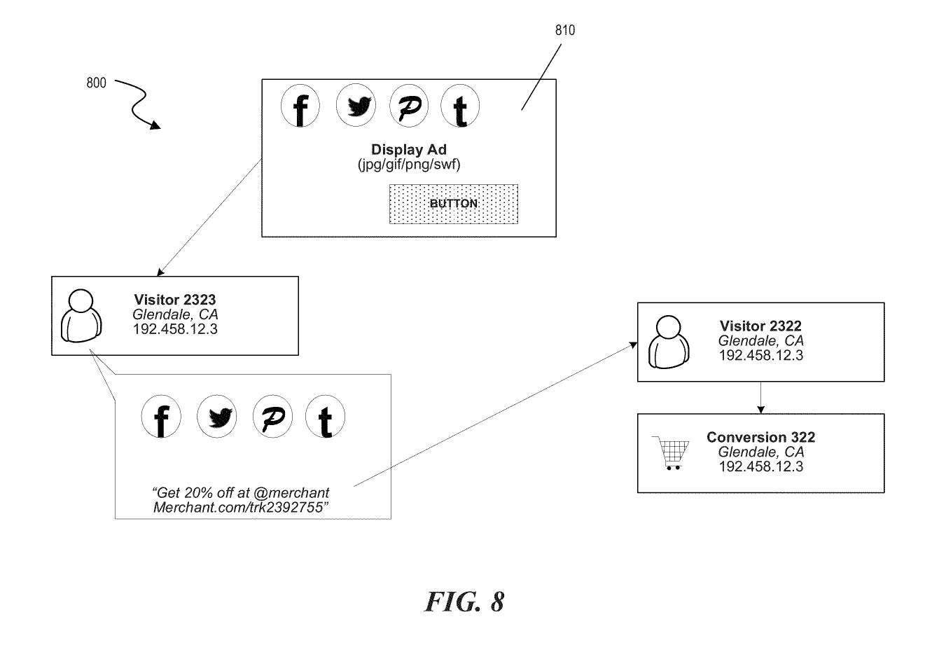

At process 516, the advertising platform creates a unique reference (or link) that corresponds to the social share. For example, as shown and discussed in greater detail with reference to FIG. 8, the user may click on the Twitter trackable social engagement object and the following tweet generated: “Get 20% off at @store store.com/trk2392755”). In this example, the tweet includes a unique reference ‘store.com/trk2392755’. Additionally, the referrer can receive a coupon directly from ad unit and share or download/email.

At process 518, the advertising platform creates a node in a node-based tracking structure. The node associates the identity (or userID) of the referrer with the unique reference so that future social engagements, e.g., reshares at process 522 and/or social conversions at process 526 can be tracked and attributed to the referrer. At process 520, the advertising platform monitors for the unique reference in order to track additional social engagement information. For example, if responsive to the referrer's tweet, a second user reshares the link, clicks on the link, or converts (i.e., social conversion) the advertisement by, for example, making a purchase or signing up for an email mailer, then this information is monitored and tracked. In some embodiments, one or more URLs are monitored to track the additional social engagement information.

As discussed, at process 522, the advertising platform determines if the referrer's social share (e.g., the tweet) has been reshared and, at process 526, the advertising platform determines if the referrer's social share (e.g., the tweet) has resulted in a social conversion. If the referrer's social share (e.g., the tweet) has been reshared then, at process 524, the advertising platform updates the referral tracking information. Once the tracking information is updated, the procedure may continue, at process 514, to identify information about the second user and subsequently, at processes 516 and 518, create a second unique reference for the second user and a second node in the node-based structure for the second. As previously discussed, the second node associates the second user with the second unique reference. In this manner, the advertising platform can generate the node-based structure and utilize the node-based structure to track social engagements.

If the referrer's social share (e.g., the tweet) has been converted then, at process 528, the advertising platform updates the conversion tracking information. Once the social conversion information is updated, the procedure may continue monitoring at process 520.

FIG. 6 is a data flow diagram depicting an example process 600 illustrating real-time bidding using social engagement metrics, according to an embodiment. Components of a referral based, node-driven advertising platform such as, for example, referral based, node-driven advertising platform 130 of FIG. 1 or host system 200 of FIG. 2 can, among other functions, perform the example process 600.

To begin, ad marketers such as, for example, ad marketers 126A-N of FIG. 1 generate an initial media inventory bid/buy or media strategy (e.g., target audience data). As discussed above, the ad marketers can be 3rd party services hired by the merchant, the merchant itself, and/or combination or variations thereof. Typically, the media strategy is developed to identify a target audience that will provide the most clicks and/or transactions (conversions) for the particular ad campaign. For example, ad marketers for a particular ad campaign (advertisement) may determine that the media strategy to achieve the most clicks and/or transaction for the campaign is to target a particular target audience, e.g., female college graduates between the ages of twenty-five and thirty years old.

Once an initial media strategy is developed, at process 610, the advertising platform directs purchase of media inventory for the particular advertisement based on the media strategy (or target audience). As discussed, ad tags can be used to convey the media strategy to the ad networks which, in turn, use the ad tags to direct the interactive advertisement to the target audience. In some embodiments, the media is purchased via a real-time bidding (RTB) system.

At process 612, the advertising platform monitors the social engagement metrics for a particular advertisement. For example, processes 524 and 528 of FIG. 5 discuss updating of the social metrics. At decision process 614, the advertising platform determines if social engagement metrics have been updated. If not, the advertising platform continues to monitor the social engagement metrics at process 612. However, if the advertising platform detects that the social engagement metrics for the particular advertisement have been updated then, at process 616, the advertising platform determines a social engagement efficacy for the various referrers. In some embodiments, a referrer's social engagement efficacy is determined based on her ability, effectiveness, success, productiveness, potency, and/or power in producing social engagements such as, for example, reshares and social conversions.

At process 618, the advertising platform optionally ranks the various referrers according to their corresponding social engagement efficacy. At process 620, the advertising platform identifies the optimal target audience (or referrers). In some embodiments, identification of the optimal target audience include identification of characteristics of the optimal target audience (or referrers). In some embodiments, referrers are identified that exceed a particular threshold. For example, referrers may be identified for being in a top percentage threshold (e.g., top 5 or 10 percent) of refers as determined by their corresponding social engagement efficacy and/or ranks. In some embodiments, the various referrers are ranked to determine the top social referrers based on social engagement efficacy. The top referrers may be referred to herein as brand evangelists because when these referrers social share interactive advertisements with their networks, the users of their networks tend to social engage with the ad.

At process 622, the advertising platform modifies and/or otherwise optimizes the media strategy based on the optimal target audience (or referrers) and/or the characteristics of the optimal target audience (or referrers). For example, if the advertising platform determines that twenty-eight year old college graduate women from Glendale, California are sharing messages about “A discount on the most comfortable mattresses” and people within their networks are clicking the links and buying the mattresses, then the advertising platform can determine the optimal target audience to be similar aged college graduate women from the Glendale area (and/or surrounding areas) to optimize the media strategy for more clicks and transactions.

In some embodiments, modifying the media strategy can include modification of the underlying ad tags. Once the ad tags are modified, at process 624, the advertising platform directs purchase of media inventory for the particular advertisement based on the modified media strategy (or revised/modified target audience). In some embodiments, the media is purchased via a real-time bidding (RTB) system.

FIG. 7 depicts an example user interface illustrating an example display ad development interface 700, according to an embodiment. The example display ad development interface 700 includes a display ad pane 710, a social engagement object activation pane 715, an advertisement network campaign manager network selection pane 730, and a code generation area 740.

The display ad pane 710 allows developers to drag and drop a creative to upload the creative. For example, a developer can drag an image file from her desktop onto the display ad pane 710 to upload the image file. The image file is then displayed in the display ad pane 710 as a display ad advertisement. A social engagement object area 725 graphically illustrates the objects or icons that are activated in the social engagement object activation pane 715.

The social engagement object activation pane 715 allows developers to activate (turn “ON”) or deactivate (turn “OFF”) individual social engagement objects (e.g., Facebook, Twitter, Pinterest, Tublr, LinkedIn, etc.). Additionally, the social engagement objects can include an email icon that allows the referrer to share the interactive advertisement via email (e.g., Yahoo Mail, Gmail, etc.) and an SMS (or phone) icon that allows the referrer to share the interactive advertisement via text messaging. Additional social engagement objects are also possible.

As shown, buttons are provided that allow the developer to turn ‘sharing’ and/or ‘following’ ON or OFF. As discussed herein, turning a social engagement object ON, activates the interactive object or icon in the social engagement object activation pane 715. A cursor 712, in the display ad pane 710, allows the developer to move and/or otherwise provide placement information for the social engagement object activation pane 715 or individual social engagement objects within the display ad pane 710. The user can also generate a call to action button 715 and provide placement information for the button within the display ad pane 710.

The advertisement network campaign manager network selection pane 730 allows the developer to select one or more advertisement network campaign manager networks on which to publish/post and/or otherwise buy media. In some embodiments, the selection(s) can affect the display code. The code generation area 740 includes a generate code button, a code area illustrating the generated code, and a copy and paste button. As discussed herein, in some embodiments, the system can generate advertising code for the interactive display ad and automatically place or post the interactive display ad to the one or more selected advertisement network campaign manager networks.

FIG. 8 depicts an example node-based social engagement tracking structure 800 illustrating tracking of social engagement metrics in the referral based, node-driven advertising platform, according to an embodiment.

In the example of FIG. 8, a display ad 810 with various trackable social engagement objects is first generated by a developer and posted or published to an advertisement network campaign manager network. Visitor 2323 from Glendale, Calif. with IP address 192.458.12.3 subsequently views the display ad 810 and clicks the Facebook icon to share the display ad 810 via Facebook. Visitor 2322 sees the Facebook post by Visitor 2323 including a unique link, clicks on the link, and completes a transaction to make a social conversion. Thus, the node-based social structure allows the system to track social engagement. Specifically, in the example of FIG. 8, the advertising platform tracks that Visitor 2322 made the social conversion based on a social share by Visitor 2323.

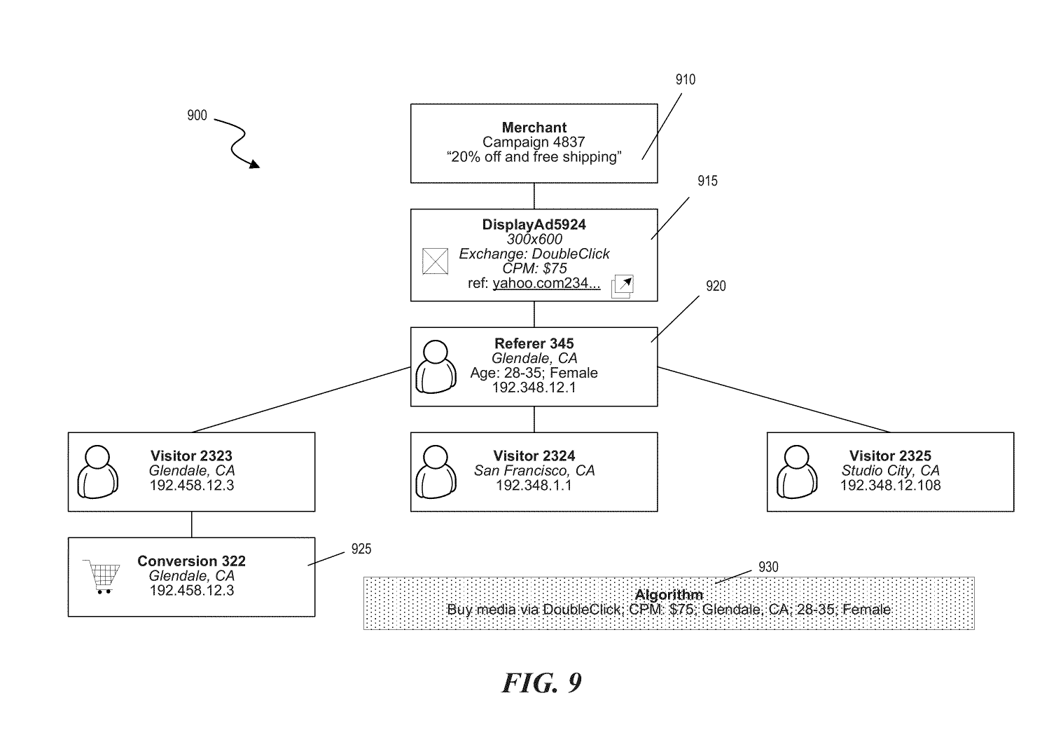

FIG. 9 depicts an example node-based social engagement tracking structure 900 illustrating modifications to a media strategy based on revisions or modifications to the optimal target audience (or referrers) and/or the characteristics of the optimal target audience (or referrers), according to an embodiment.

In the example of FIG. 9, at node 910, a display ad 910 with various trackable social engagement objects is first generated by a developer. At node 915, the display ad is posted or published to an advertisement network campaign manager network at node. Specifically, display ad 5924 is posted or published. The display ad 910 makes an impression on Referrer 345 and, at node 920, Referrer 345 socially shared the display ad 910. Visitors 2323, 2324, and 2325 each socially interact with the socially shared display ad 910 and Visitor 2323 socially converts at node 925.

The advertising platform processes the tracked social engagement information and determines that Referrer 345 is a top referrer. The optimal target audience is then modified or revised for the ad campaign such that the target audience includes one or more characteristics of the same or similar to Referrer 345. Based on this information, the advertising platform can then direct a new media buy based on the modified or revised target audience information. As shown in the example of FIG. 9, the advertising platform makes the following determination: Buy media via DoubleClick; CPM: $75; Glendale, Calif.; 28-35; Female. Ad tags and programmatic buying algorithm can be modified accordingly.

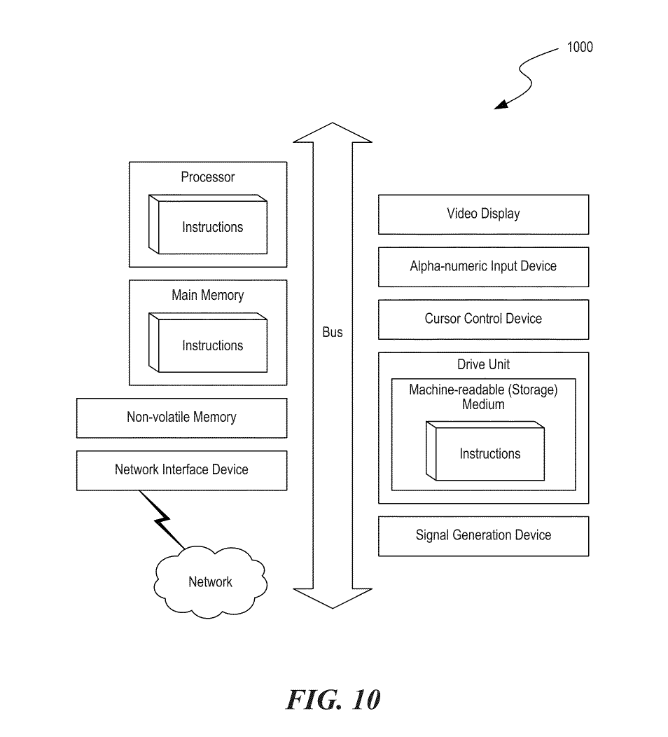

FIG. 10 depicts a diagrammatic representation of a machine, in the example form, of a computer system within which a set of instructions, for causing the machine to perform any one or more of the methodologies discussed herein, may be executed.

In the example of FIG. 10, the computer system 1000 includes a processor, memory, non-volatile memory, and an interface device. Various common components (e.g., cache memory) are omitted for illustrative simplicity. The computer system 1000 is intended to illustrate a hardware device on which any of the components depicted in the example of FIG. 1 (and any other components described in this specification) can be implemented. The computer system 800 can be of any applicable known or convenient type. The components of the computer system 800 can be coupled together via a bus or through some other known or convenient device.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 800. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium”. A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 10 reside in the interface.

In operation, the computer system 1000 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are, at times, shown as being performed in a series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method comprising:
detecting, by one or more processors of an advertising platform, a social engagement action performed by a first social referrer on an embedded social engagement object of an interactive advertisement;
processing the social engagement action to identify a user identifier and additional user information associated with the first social referrer;
creating, by the or more processors, a reference that uniquely identifies the user identifier;
monitoring the reference to detect additional social engagement activity from additional social referrers; and
attributing the additional social engagement activity to the first social referrer.

2. The method of claim 1, further comprising:
saving the reference to memory in a node-based tracking structure,
wherein saving the reference comprises generating a node in the node-based social engagement structure that uniquely identifies the user identifier and associates the user identifier with the social engagement action.

3. The method of claim 1, wherein the additional social engagement activity comprises social conversions corresponding to the reference and reshares of the reference by the additional social referrers.

4. The method of claim 1, further comprising:
determining real-time target audience information responsive to detection of the additional social engagement activity.

5. The method of claim 4, wherein determining the real-time target audience information comprises:
determining a social engagement efficacy for social referrers socially engaged with the interactive advertisement;
ranking the multiple social referrers according to theirs corresponding social engagement efficacy; and
selecting a subset of the multiple social referrers that exceed a social referrer threshold,
wherein the subset of the multiple social referrers are used to determine target audience information.

6. The method of claim 5, further comprising:
identifying characteristics of the subset of the multiple social referrers to determine the target audience information.

7. The method of claim 4, further comprising:
directing purchase of media inventory via a real-time bidding system based on the real-time target audience information.

8. The method of claim 1, further comprising:
providing a display ad interface to a developer for development of the interactive advertisement;
receiving, at the display ad interface, an image file uploaded by the developer via drag and drop;
providing, via the display ad interface, the developer a selection of one or more types of social engagement objects to include on the interactive advertisement,
wherein the social engagement objects are trackable using a node-based social engagement structure;
receiving first developer input indicating selection of one or more trackable social engagement objects to include on the interactive advertisement;
creating the selected one or more trackable social engagement objects responsive to receiving the first developer input;
receiving second developer input indicating placement information of the selected trackable social engagement objects on the interactive advertisement;
embedding the trackable social engagement objects on the interactive advertisement; and
creating an advertisement code for the interactive advertisement.

9. The method of claim 8, further comprising:
receiving third developer input indicating one or more selected advertisement network campaign manager networks; and
automatically deploying the code to the selected advertisement network campaign manager networks.

10. The method of claim 9, wherein the code comprises an iFrame code.

11. An advertising platform comprising:
one or more processors;
a memory system having instructions stored thereon, which when executed by the one or more processors, cause the advertising platform to:
detect a social engagement action performed by a first social referrer on an embedded social engagement object of an interactive advertisement;
process the social engagement action to identify a user identifier and additional user information associated with the first social referrer;
create a reference that uniquely identifies the user identifier;
monitor the reference to detect additional social engagement activity from additional social referrers; and
attribute the additional social engagement activity to the first social referrer.

12. The advertising platform of claim 11, wherein the instructions, when executed by the one or more processors, further cause the advertising platform to:
save the reference to a non-transitory memory unit using a node-based tracking structure,
wherein saving the reference includes generating a node in the node-based social engagement structure that uniquely identifies the user identifier and associates the user identifier with the social engagement action.

13. The advertising platform of claim 1, wherein the additional social engagement activity comprises social conversions corresponding to the reference and reshares of the reference by the additional social referrers.

14. The advertising platform of claim 11, wherein the instructions, when executed by the one or more processors, further cause the advertising platform to:
determine real-time target audience information responsive to detection of the additional social engagement activity.

15. The advertising platform of claim 4, wherein to determine the real-time target audience information, the advertising platform:
determines a social engagement efficacy for social referrers socially engaged with the interactive advertisement;
ranks the multiple social referrers according to theirs corresponding social engagement efficacy; and
selects a subset of the multiple social referrers that exceed a social referrer threshold,
wherein the subset of the multiple social referrers are used to determine target audience information.

16. The advertising platform of claim 15, wherein the instructions, when executed by the one or more processors, further cause the advertising platform to:
identify characteristics of the subset of the multiple social referrers to determine the target audience information.

17. The advertising platform of claim 11, wherein the instructions, when executed by the one or more processors, further cause the advertising platform to:
direct purchase of media inventory via a real-time bidding system based on the real-time target audience information.

18. The advertising platform of claim 11, wherein the instructions, when executed by the one or more processors, further cause the advertising platform to:
provide a display ad interface to a developer for development of the interactive advertisement,
wherein the display ad interface allows the developer to upload an image file by dragging and dropping the image file onto a specified area of the display ad interface;
provide, via the display ad interface, the developer a selection of one or more types of social engagement objects to include on the interactive advertisement,
wherein the social engagement objects are trackable using a node-based social engagement structure;
create developer one or more developer selected trackable social engagement objects;
embed the trackable social engagement objects on the interactive advertisement based on placement information provided by the developer; and
create an advertisement code for the interactive advertisement.

19. The advertising platform of claim 18, wherein the instructions, when executed by the one or more processors, further cause the advertising platform to:
automatically deploy the interactive advertisement to one or more selected advertisement network campaign manager networks.

20. A computer readable storage medium having instructions stored thereon that, when executed by a processing system, cause the processing system to:
detect a social engagement action performed by a first social referrer on an embedded social engagement object of an interactive advertisement;
process the social engagement action to identify a user identifier and additional user information associated with the first social referrer;
create a reference that uniquely identifies the user identifier;
monitor the reference to detect additional social engagement activity from additional social referrers; and
attribute the additional social engagement activity to the first social referrer.
